(19) United States
(12) Patent Application Publication
(10) Pub. No.: US 2009/0229080 A1
(43) Pub. Date: Sep. 17, 2009

(54) Automated hinge assembly

(75) Inventor: Chia-Hsiang Chen, Shulin City (TW)

Correspondence Address: JACKSON WALKER, L.L.P., 112 E. PECAN, SUITE 2400, SAN ANTONIO, TX, 78205, US

(73) Assignee: Shin Zu Shing Co., Ltd.

(21) Appl. No.: 12/077,107

(22) Filed: Mar. 17, 2008

(51) Int. Cl. E05D 3/04; E05D 7/00; E05D 11/06

(52) U.S. Cl. 16/295; 248/213.1; 16/363

(57) ABSTRACT

An automated hinge assembly has at least two leaves and a driving member. The leaves respectively connect securely to a cover and a body of a portable electronic device and are connected pivotally together. The driving member is mounted between the leaves and has a resilient element, a stationary bracket and a sliding bracket. The resilient element provides a force to automatically pivot a moving leaf from a stationary leaf. The stationary bracket has at least one inclined surface formed circularly around a central axis. The sliding bracket is pushed by the resilient element and has at least one protrusion corresponding to and abutting the inclined surface of the stationary bracket, thereby generating a torque to drive the leaf connected to the stationary bracket to rotate relative to another leaf.

### BACKGROUND OF THE INVENTION

1. Field of the Invention

The present invention relates to a hinge, and more particularly to an automated hinge assembly that can be mounted in a portable electronic device having a latched cover and a body, the cover opening when unlatched and is able to rotate relative to the body while unlatched.

2. Description of Related Art

Hinges are widely used in various portable electronic devices, such as laptops, mobile phones, hand-held cameras, digi-camcorders and the like. Generally, a portable electronic device comprises a body, a cover and at least one hinge. The cover may have a display mounted therein. The hinge pivotally connects the cover to the body and allows the cover to pivot relative to the body.

However, conventional hinges require an external force to be applied to operate. Therefore, the cover must be turned by hand or tool to open the cover. This makes opening the cover inconvenient and time-consuming.

To overcome the shortcomings, the present invention provides an automated hinge assembly to obviate or mitigate the aforementioned problems.

### SUMMARY OF THE INVENTION

The main objective of the present invention is to provide an automated hinge assembly that is mounted in a portable electronic device to allow a cover to rotate automatically relative to a body when the cover is unlatched.

To achieve the objective, the automated hinge assembly in accordance with present invention comprises at least two leaves and a driving member.

The leaves respectively connect securely to a cover and a body of a portable electronic device and has a pintle mounted therebetween to make the leaves pivoting relative to each other. The driving member is mounted on the pintle between the leaves, may be a twisted torsion spring generating a torque, or preferably comprises a stationary bracket, a sliding bracket and a resilient element. The stationary bracket is mounted securely with one of the leaves and has at least one inclined surface formed circularly around a central axis. The sliding bracket is mounted movably on the pintle and rotates simultaneously relative to the other leaf while moving. The sliding bracket has at least one protrusion corresponding to and abutting the inclined surface of the stationary bracket. The resilient element is mounted immovably on the pintle and pushes the sliding bracket to move toward the stationary bracket. Conseuquently, the protrusion of the sliding bracket presses the inclined surface of the stationary bracket to generate a torque to drive the leaf connecting with the cover rotate relative to the body.

In such a manner, the cover mounted with the leaf connecting with the twisted torsion spring, or preferably with the leaf connected with the stationary bracket is able to pivot automatically relative to the body while the cover is unlatched without any external force applying to the cover. Thus, the portable electronic device with the automated hinge assembly in accordance with present invention is convenient and timesaving to use.

Additionally, the at least one protrusion may also be formed on the stationary bracket while the corresponding at least inclined surface is formed on the sliding bracket to generate torque.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an automated hinge assembly in accordance with the present invention;

FIG. 2 is an exploded perspective view of the automated hinge assembly in FIG. 1;

FIG. 3 is an another exploded perspective view of the automated hinge assembly in FIG. 1;

FIG. 4 is a side view of the automated hinge assembly in FIG. 1;

FIG. 5 is an another side view of the automated hinge assembly in FIG. 1;

FIG. 6 is a top view of the automated hinge assembly in FIG. 1;

FIG. 7 is an operational perspective view of the automated hinge assembly in FIG. 1 mounted in the portable electronic device shown in phantom lines;

FIG. 8 is an operational rear-end view of the automated hinge assembly in FIG. 1 mounted in the portable electronic device shown in phantom lines; and

FIG. 9 is a perspective view of an another embodiment of an automated hinge assembly in accordance with the present invention.

### DETAILED DESCRIPTION OF THE PREFERRED EMBODIMENT

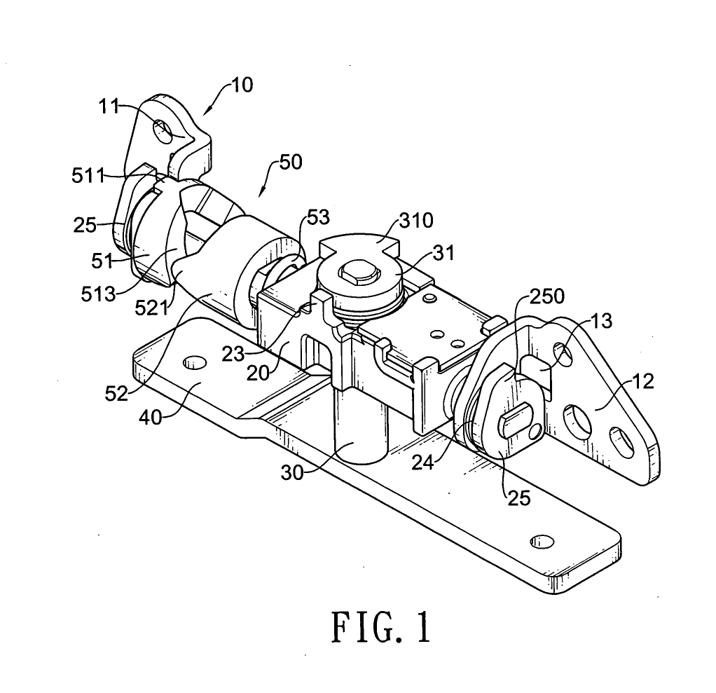

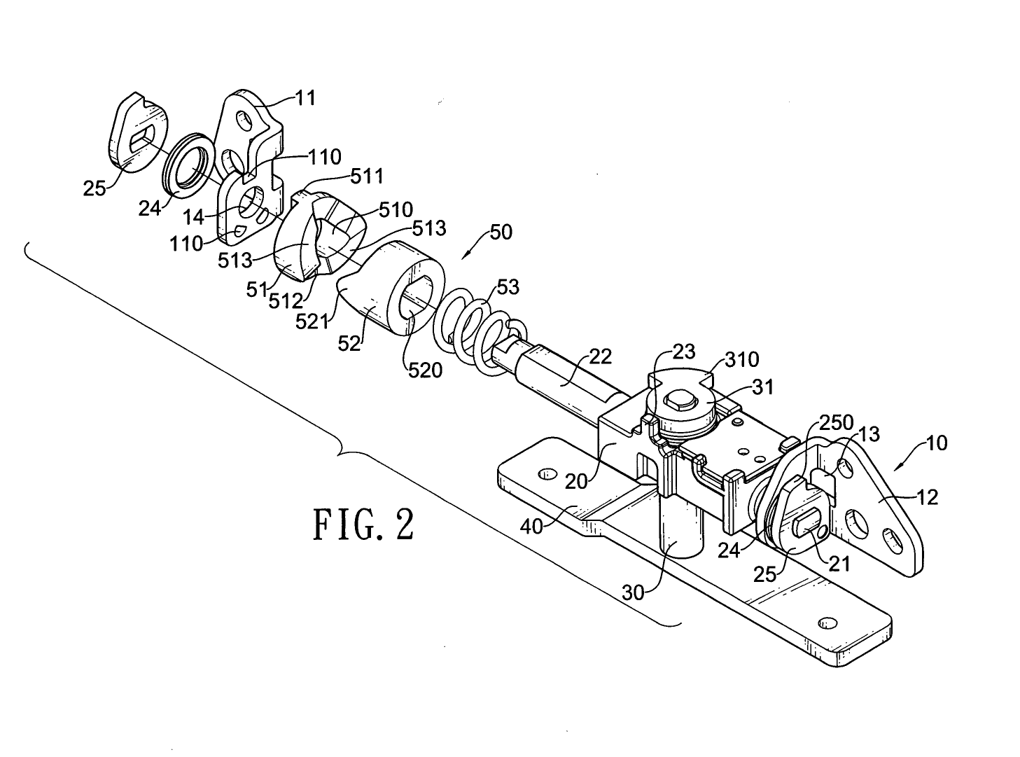

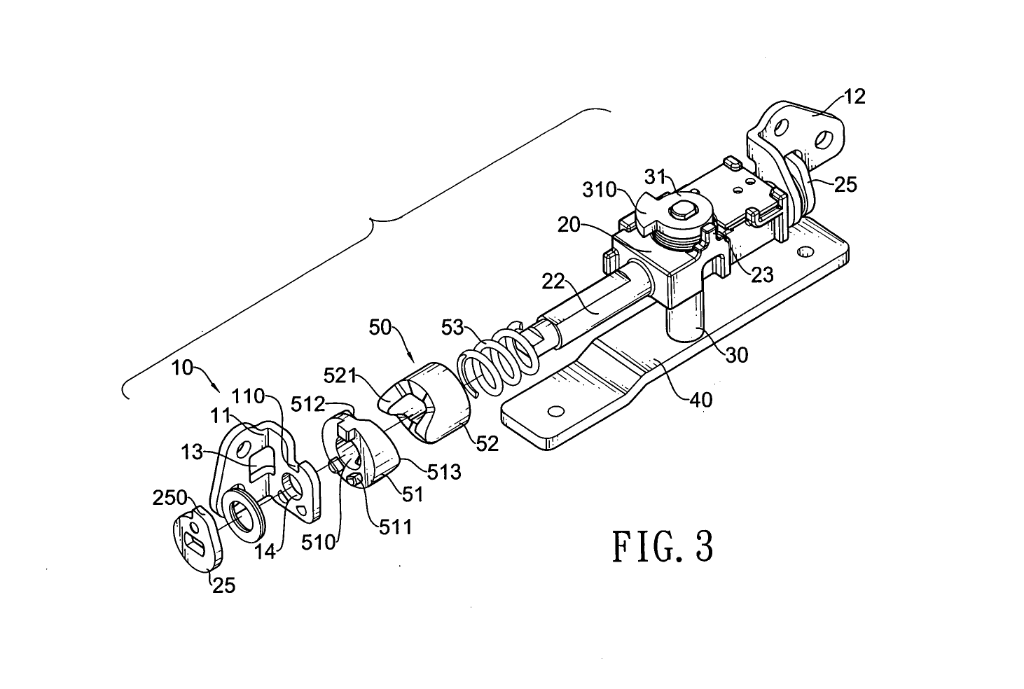

With reference to FIGS. 1, 2, 3 and 9, an automated hinge assembly in accordance with present invention comprises a moving leaf (40), a base (20), a driving member (50), a stationary leaf assembly (10) and two fastener assemblies.

The stationary leaf assembly (10) has a main stationary leaf (11) and a support stationary leaf (12). The stationary leaves (11, 12) are L shaped and each has an attachment end, a mounting end, a limiting notch (13) and a pintle hole (14). The limiting notch (13) is formed through the attachment end. The pintle hole (14) is defined through the mounting end. The main stationary leaf (11) further has at least one engaging mount (110) formed adjacent to the pintle hole (14).

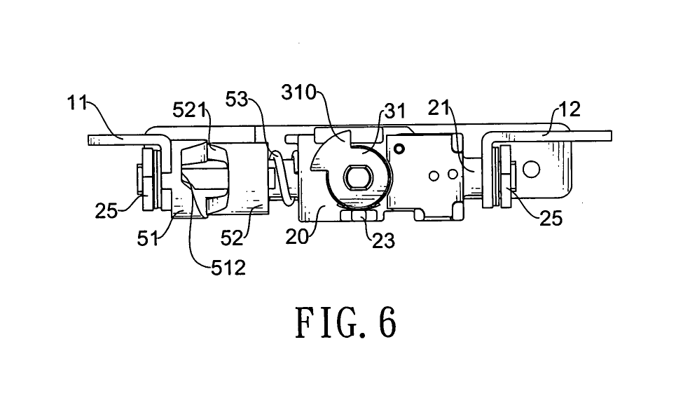

With further reference to FIG. 6, the moving leaf (40) has an attachment portion and a shaft (30).

The shaft (30) is formed on and protrudes from the attachment portion of the moving leaf (40) and has a distal end and a limit (31). The limit (31) is mounted securely on the distal end of the shaft (30) and has a limiting protrusion (310). The limiting protrusion (310) is formed on and protrudes radially from the limit (31).

The base (20) is mounted rotatably on the distal end of the shaft (30) and has a limiting surface, a central hole, two ends, a main pintle (22), a support pintle (21) and a stop (23). The limiting surface is disposed adjacent to the limit (31) of the shaft (30). The central hole is mounted around the distal end of the shaft (30). The main pintle (22) and the support pintle (21) have non-circular distal ends, are formed on and protruding respectively from the ends of the base (20) and respectively mount rotatably through the pintle holes (14) of the stationary leaves (11, 12). The stop (23) is formed on and protrudes from the limiting surface of the base (20) beside the central hole.

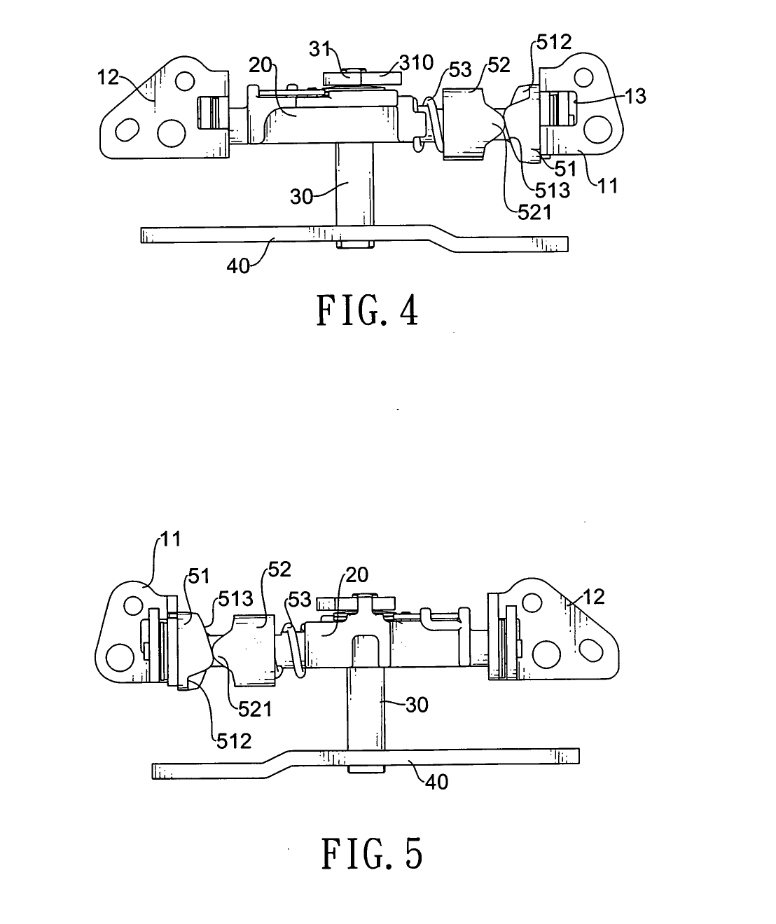

With further reference to FIGS. 4 and 5, the driving member (50) is mounted around the main pintle (22) of the base (20) and comprises a resilient element (53), a sliding bracket (52) and a stationary bracket (51).

The resilient element (53) is mounted around the main pintle (22) and has two ends. One of the ends of the resilient element (53) abuts one end of the base (20).

The sliding bracket (52) is engaged and mounted slidably on the main pintle (22) of the base (20), is rotated simultaneously with the moving leaf (40) and base (20) and has an inner surface, an outer surface, an engaging hole (520) and two protrusions (521). The engaging hole (520) is formed through the sliding bracket (52) and corresponds to the main pintle (22), such that the sliding bracket (52) slidably engages the main pintle (22) of the base (20). The protrusions (521) are oppositely formed on and protrude from the outer surface of the sliding bracket (52).

The stationary bracket (51) is mounted rotatably around the main pintle (22) of the base (20) and has an outer surface, a through hole (510), at least one boss (511) and two recesses (512). The through hole (510) is formed through the stationary bracket (51) and is mounted rotatably around the main pintle (22). The bosses (511) are formed on the outer surface of the stationary bracket (51) and be mounted securely in the engaging mount (110) of the main stationary leaf (11). The cutouts (512) are formed in the inner surface of the stationary bracket (51), and each cutout (512) defines an inclined surface (513) formed circularly around a central axis of the stationary bracket (51) The inclined surfaces of the cutouts (512) respectively correspond to and abut the protrusions (521).

The protrusions (521) of the sliding bracket (52) continuously press the inclined surfaces (513) of the stationary bracket (51) to generate a torque and thereby drive the base (20) and the moving leaf (40) to rotate relative to the stationary leaf assembly (10).

Each fastener assembly comprises a washers (24) and a fastener (25). The washers (24) are respectively mounted securely on the distal ends of the pintles (21, 22). The fasteners (25) are mounted on the distal ends of corresponding pintles (21, 22), may be using riveting, welding or the like. Each fastener (25) has an abutting portion (250) protruding from the fastener (25) corresponding to and selectively abutting an edge of the limiting notch (13) of the corresponding stationary leaf (11, 12) to limit an angle of rotation of the base (20) relative to the stationary leaf assembly (10).

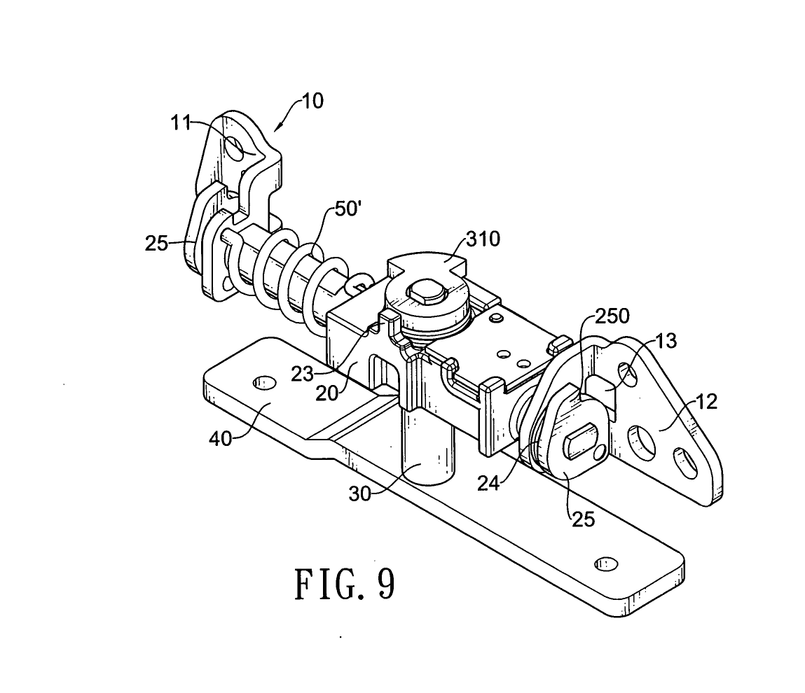

With reference to FIG. 9, in another embodiment, the driving member (50) is replaced by a twisted torsion spring (50′). The torsion spring (50′) is mounted immovably around the main pintle (22) of the base (20) and has two ends respectively attached securely to one end of the base (20) and the main stationary leaf (11). Thereby, the torsion spring (50′) continuously generates a torque to drive the base (20) and the moving leaf (40) rotate relative to the stationary leaf assembly (10).

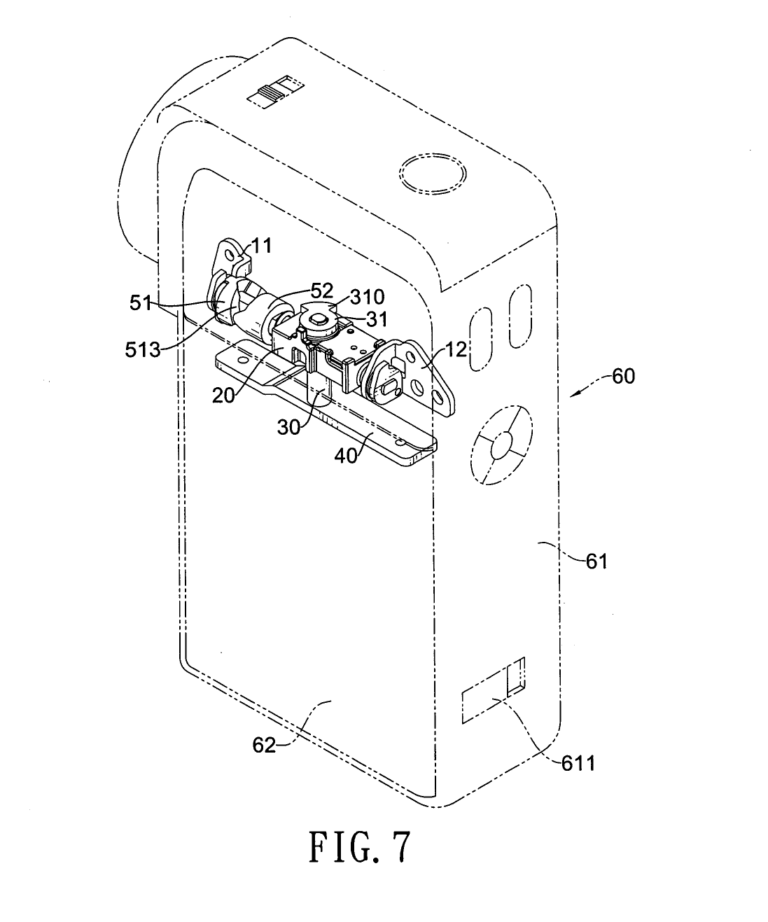

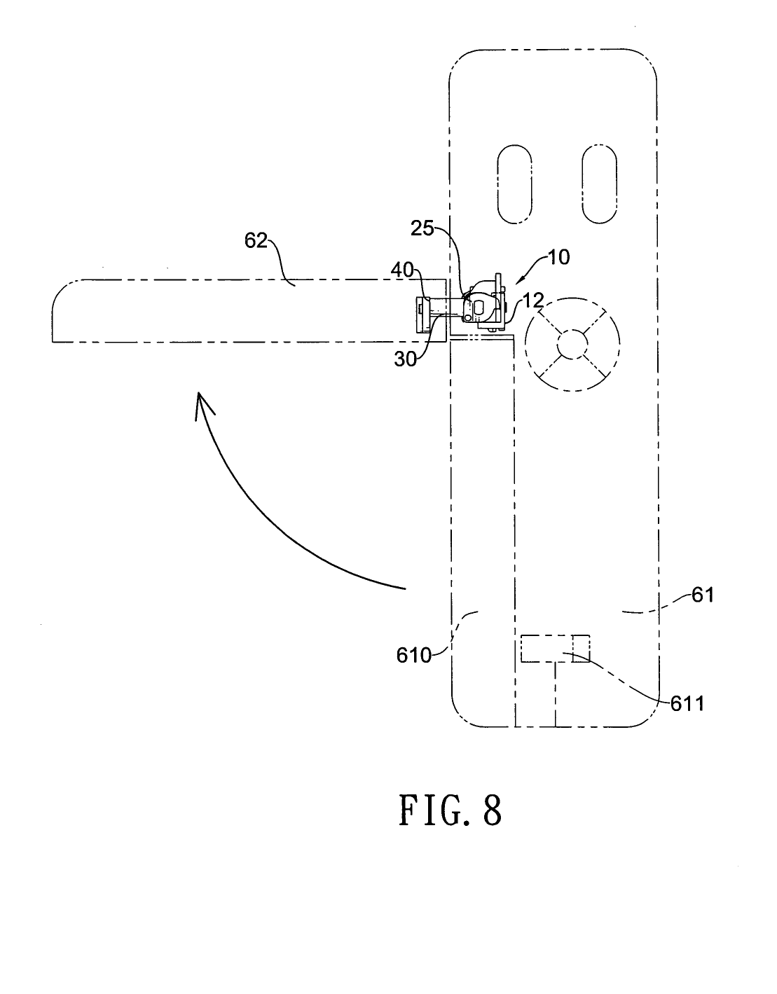

With further reference to FIGS. 7 and 8, a portable electronic device (60), may be a hand-held camera, comprises a body (61) a cover (62) and a controllable latch (611). The cover (62) is attached to the moving leaf (40), and is mounted to the base (20) with the stationary leaf (10). The latch (611) holds the cover shut and may be a bar, hook or the like. When the latch (611) is released, the resilient element (53) pushes the cover (62) open and the cover (62) opens on one axis by rotation of the pintles (21, 22) relative to the stationary leaves (11, 12) and may be rotated on a different axis by rotation of the shaft (30) and the moving leaf (40).

Accordingly, the portable electronic device (60) with the automated hinge assembly in accordance with present invention is convenient to use.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. An automated hinge assembly comprising
a stationary leaf assembly;
a moving leaf connected with a pintle that is rotatably connected with the stationary leaf assembly; and
a driving member mounted on the pintle comprising
a stationary bracket mounted around the pintle and secured with the stationary leaf assembly and having
two ends; and
at least one cutout being formed in one end of the stationary bracket and each one of the at least one cutout defining an inclined surface formed circularly around a central axis of the stationary bracket;
a sliding bracket mounted movably on the pintle relative to the stationary bracket, simultaneously rotated with the moving leaf and having
a distal end;
a proximal end; and
at least one protrusion being formed on the distal end respectively corresponding to and abutting the at least one inclined surface of the stationary bracket;
a resilient element being mounted immovably around the pintle and having two ends, one of the ends of the resilient element abutting the proximal end of the sliding bracket and pushing the sliding bracket to move toward the stationary bracket and to make each one protrusion of the sliding bracket pressing a corresponding inclined surface of the stationary bracket and thereby generating a torque to drive the moving leaf pivoting relative to the stationary leaf assembly.

2. The automated hinge assembly as claimed in claim 1, wherein
the stationary leaf assembly comprises a main stationary leaf and a support stationary leaf, and each of the main stationary leaf and the support stationary leaf having
a mounting end;
an attachment end; and
a pintle hole being defined through the mounting end and corresponding to the pintle hole in the other stationary leaf of the stationary leaf assembly; and
the automated hinge assembly further comprises a base connecting pivotally with the moving leaf and having a top surface and two ends;
wherein the pintle is composed of a main pintle and a support pintle being longitudinally protruding respectively from the ends of the base and extending respectively through the pintle holes of the main stationary leaf and a support stationary leaf of the stationary leaf assembly and allowing a rotation of the main pintle and the support pintle in the pintle holes; and
two washers and two fastener being separately mounted respectively on the main pintle and the support pintle to hold the main pintle and the support pintle stably on the stationary leaf assembly.

3. The automated hinge assembly as claimed in claim 2, wherein
the main pintle of the base is non-circular in cross section; and
the sliding bracket is mounted movably on the main pintle of the base and has an engaging hole being formed through the sliding bracket and being non-circular in cross section that fitting the main pintle, such that the sliding bracket engages the main pintle of the base in a slidable manner and simultaneously rotating with the base and the moving leaf.

4. The automated hinge assembly as claimed in claim 2, wherein
the moving leaf further has a shaft being mounted rotatably in the base and having a bottom end connecting with the moving leaf.

5. The automated hinge assembly as claimed in claim 4, wherein
the base further has a stop protruding from the top surface of the base beside the central hole; and
the shaft further has
a distal end protruding from the central hole of the base; and
a limit being mounted securely in the distal end of the shaft and having a limiting protrusion radially protruding from the limit for abutting the stop of the base to limit a rotation angle of the shaft relative to the base.

6. The automated hinge assembly as claimed in claim 2, wherein
the stationary bracket has two cutouts being oppositely formed in one end of the stationary bracket; and
the sliding bracket has two protrusions being formed on the distal end corresponding to and abutting the inclined surfaces of the cutouts of the stationary bracket.

7. The automated hinge assembly as claimed in claim 2, wherein
the main stationary leaf further has at least one engaging mount formed adjacent to the pintle hole;
the stationary bracket further has multiple bosses engaging the engaging mount of the main stationary leaf of the stationary leaf assembly to securely mount the stationary bracket with the main stationary leaf of the stationary leaf assembly.

8. The automated hinge assembly as claimed in claim 2, wherein
each of the main stationary leaf and the support stationary leaf further has a limiting notch being formed through the attachment end of the main stationary leaf and the support stationary leaf;
each fastener of the base has an abutting portion protruding from the fastener to abut an edge of the limiting notch of a corresponding one of the main stationary leaf and the support stationary leaf of stationary leaf assembly to limit a rotation angle of the base relative to the stationary leaf assembly.

9. The automated hinge assembly as claimed in claim 2, wherein each of the main stationary leaf and the support stationary leaf is “L” shaped.

10. An automated hinge assembly comprising
a stationary leaf assembly comprising a main stationary leaf and a support stationary leaf, each of the main stationary leaf and the support stationary leaf having a pintle hole corresponding to the pintle hole in the other stationary leaf of the stationary leaf assembly;
a moving leaf;
a base connecting with the moving leaf and having
two ends;
a main pintle and a support pintle being longitudinally protruding respectively from the ends of the base and extending respectively through the pintle holes of the main stationary leaf and the support stationary leaf of the stationary leaf assembly and allowing a rotation of the main pintle and the support pintle in the pintle holes;
a shaft being mounted rotatably in the base and having a bottom end connecting with the moving leaf; and
a driving member being a torsion spring that is mounted around the main pintle of the base and having two ends respectively attached securely to one end of the base and the main stationary leaf, thereby continuously generating a torque to drive the base and the moving leaf rotate relative to the stationary leaf assembly.
